(19) United States
(12) Patent Application Publication
(10) Pub. No.: US 2005/0108176 A1
(43) Pub. Date: May 19, 2005

(54) Configurable rules based content item consumption

(76) Inventors: Scott B. Jarol, Seattle, WA (US); Erik W. Selberg, Seattle, WA (US); Randy Meyerson, Seattle, WA (US); Qin Cai, Sammamish, WA (US); Chelsea C. Krueger, Bellevue, WA (US); David Hedbor, Issaquah, WA (US)

Correspondence Address: SCHWABE, WILLIAMSON & WYATT, P.C., 1211 SW FIFTH AVENUE, SUITES 1600-1900, PORTLAND, OR, 97204, US

(21) Appl. No.: 10/836,646

(22) Filed: Apr. 30, 2004

Related U.S. Application Data
(60) Provisional application No. 60/467,249, filed on Apr. 30, 2003.

(51) Int. Cl. G06F 17/60

(52) U.S. Cl. 705/59

(57) ABSTRACT

In accordance with at least one aspect of the present invention, a content provider functions as a content rights broker facilitating the acquisition of content item consumption rights from one or more licensing or rights provisioning authorities on behalf of consumers, based upon configurable business rules logic used by the content provider to derive appropriate sets of rights based upon a content item to be consumed.

### RELATED APPLICATIONS

This application claims priority to provisional application Ser. No. 60/467,249 filed on Apr. 30, 2003 and entitled “CONFIGURABLE CONTENT ITEM LICENSING”.

### BACKGROUND OF THE INVENTION

1. Field of the Invention

The present invention relates generally to the field of digital rights management. More specifically, the present invention relates to a method and apparatus for configurable content item licensing.

2. Background Information

With advances in integrated circuit, microprocessor, networking and communication technologies, an increasing number of digital computing devices are being networked together to facilitate the exchange of electronic information. Accordingly, traditional audio and video content providers such as radio and television studios, recording associations, independent recording artists, and so forth, have turned to digital communication networks such as the Internet for dissemination and distribution of media content.

Various content publishers own publication rights to digital content that they wish to offer to an entitled audience of consumers. Typically, content partners will grant entitlements to consumers based on a form of payment, whether it be on a per content item basis, or for a subscription that represents an entire class of content items. Publishers may also choose to offer entitlement without payment for specific content items, or for classes of content items. Furthermore, entitlement may be determined by other factors such as geographic location, network address, calendar or time constraints, etc.

In current digital rights management systems, content publishers are required to manually program the content distribution/licensing rules into e.g. a content server to implement a particular content distribution/licensing business model. With such a wide variety of distribution/licensing models available, the corresponding business logic required to implement the business models may vary widely. If a given content provider wishes to change to another content distribution/licensing model, they are currently required to manually reprogram the implementing business rules to the exclusion of the current distribution/licensing model.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a networking environment designed to facilitate configurable content item licensing, in accordance with one embodiment of the invention;

FIG. 2 illustrates one embodiment of a rights template chain and corresponding rules and consumption rights grants, representing the example content distribution/licensing business model;

FIG. 3A illustrates one embodiment of a consumption rights matrix formed from an ordered grouping of rights templates;

FIG. 3B is an operational flow diagram illustrating one method for traversing a consumption rights matrix, in accordance with one embodiment of the invention;

FIG. 4 illustrates an operational flow of one embodiment of a consumption rights matrix generation process, in accordance with one embodiment of the invention;

FIG. 5 illustrates various member elements of one embodiment of a consumption rights matrix;

FIGS. 6A-6F illustrate various user interface dialogs for cunsumption rights matrix generation in accordance with one embodiment of the invention;

FIG. 7 illustrates an example operational flow for content rights broker 102, in accordance with one embodiment of the invention; and

FIG. 8 illustrates an example system suitable for practicing the present invention.

### DETAILED DESCRIPTION OF EMBODIMENTS OF THE INVENTION

In the description to follow, various aspects of the present invention will be described, and specific configurations will be set forth. However, the present invention may be practiced with only some or all aspects, and/or without some of these specific details. In other instances, well-known features are omitted or simplified in order not to obscure the present invention.

The description will be presented in terms of operations performed by a processor based device consistent with the manner commonly employed by those skilled in the art to convey the substance of their work to others skilled in the art. As is well understood by those skilled in the art, the quantities take the form of electrical, magnetic, or optical signals capable of being stored, transferred, combined, and otherwise manipulated through mechanical, electrical and/or optical components of the processor based device.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous.

### Overview

In accordance with at least one aspect of the present invention, a content provider functions as a content rights broker facilitating the acquisition of content item consumption rights from one or more licensing or rights provisioning authorities on behalf of consumers, based upon configurable business rules logic used by the content provider to derive appropriate sets of rights based upon a content item to be consumed.

In one embodiment of the invention, in response to a consumer's attempt to consume a content item that has been encrypted (or otherwise protected) and published in accordance with one or more content distribution/licensing business models, a client device associated with the consumer may submit a content item decryption request to an indicated content provider equipped with the teachings of the present invention. In accordance with one embodiment of the invention, the content provider may be equipped with configurable business rules logic to identify an appropriate set of distribution/licensing business rules corresponding to the content item indicated by the request, and to determine a set of consumption rights to be granted to the client with respect to the content item based upon successful application of the identified set of rules. In one embodiment, the content provider may utilize a content item-specific consumption rights matrix to identify a set of rights to be granted. In one embodiment, the consumption rights matrix may be based upon an ordered grouping of rights templates arranged in one or more rights template chains with each rights template chain corresponding to two or more sets of mutually exclusive rights.

Once an appropriate set or sets of rights have been determined in relation to the requested content item, the content provider may obtain a content item-specific consumption rights grant embodying those rights from one of potentially numerous licensing authorities on behalf of the consumer, and return the consumption rights grant to the requesting client to facilitate decryption and consumption of the content item. In one embodiment, the content item-specific consumption rights grant may represent a content item license.

The terms “content items”, “media item”, “media resource” and “media content”, are each intended to broadly and interchangeably refer to data such as, but not limited to audio and video (including motion video and still images) clips, data files, streams, and so forth, whether alone or combined, that may be rendered by a user agent. However, the terms “content items”, “media item”, “media resource” and “media content” need not necessarily be limited to audio and video related content, although they may.

Moreover, the terms “consumption” and “consume” as used herein with respect to content items (as well as media items, media resources and/or media content), are intended to broadly refer to one or more actions that are performed on or with respect to a given content item. For example, consumption may involve the access and/or retrieval of a particular content item (whether from memory or a storage device), playback of a content item, transcoding of the content item, transferring or “burning” the content item to a CD-ROM or similar large capacity removable storage media (including CD-R, CD-RW, DVD−RW, DVD+RW, DVD-RAM, and so forth), downloading the content item to a portable player device, and so forth.

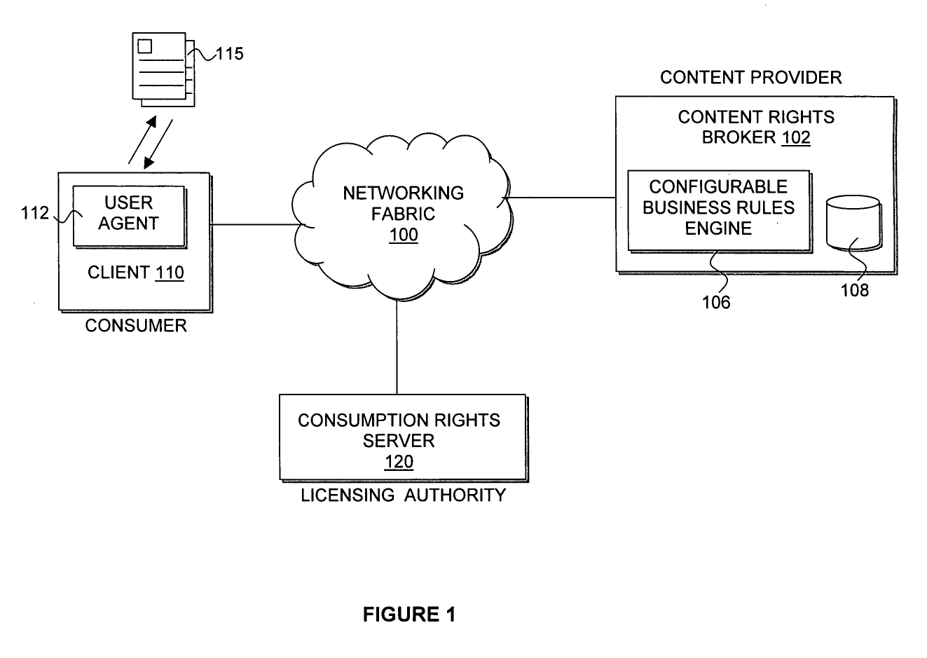

FIG. 1 illustrates a networking environment designed to facilitate configurable content item licensing, in accordance with one embodiment of the invention. As illustrated, content rights broker 102 may be communicatively coupled to client 110 and consumption rights server 120 via networking fabric 100.

Networking fabric 100 may represent a variety of data communication networks ranging from, for example, a local network such as an intranet, to one or more global interconnected networks such as the Internet or World Wide Web.

Content rights broker 102 may represent one or more content provider based server devices equipped with configurable business rules engine 106 (hereinafter “rules engine 106”) and data repository 108 to provide configurable content item licensing services to client devices, such as client 110, in accordance with the teachings of the present invention. More specifically, in one embodiment, content rights broker 102 may utilize one or more data structures stored in data repository 108 to facilitate configurable content item licensing services of the present invention. Although data repository 108 is represented as a discrete data storage device, data repository 108 may nonetheless represent multiple independent storage devices or a unified array of storage devices.

Client 110 may represent a broad range of digital systems, including devices such as wireless mobile phones, palm sized personal digital assistants, and other general purpose or dedicated portable player devices, notebook computers, desktop computers, set-top boxes, game consoles, and so forth. In one embodiment, client 110 represents a client device that may be equipped with user agent 112, such as a media player or browser application, designed to facilitate consumption of content items 115 stored locally or accessed remotely across networking fabric 100 for example.

Consumption rights server 120 represents a server device equipped with rights management facilities to issue content item licenses and other entitlement based consumption rights grants to facilitate decryption and playback of various encrypted content items e.g. by client devices. In one embodiment, consumption rights server 120 and content rights broker 120 may be operationally independent from each other in that they are operated by independent entities. In other embodiments, consumption rights server 120 and content rights broker 102 may be operated by the same entity. The term ‘entity’ is intended to broadly refer to a physical or legally defined company, group, individual, server, computer, service center and so forth, that has a separate and distinct existence, such as an agent, one or more subsidiaries, affiliated companies, division of a company, employee, server systems, and so forth.

### Distribution/Licensing Business Model

A basic subscription based business model may enable users to pay a recurring, periodic charge for unlimited access to all content belonging to a content class. Variations on such a subscription model may include metered access models as well as models that apply constraints on entitlement provisioning and license renewability. In a metered business model, users may acquire period-limited access to a limited number of content selections, which they may choose from a larger number of available items. For example, a record company may offer a catalogue of thousands of individual music tracks, from which their subscribers may be restricted to several dozen or several hundred each month. In a further variation on metering, users may obtain consumption rights grants or licenses for a limited number of content items each month, but may renew those consumption rights grants/licenses indefinitely for as long as they continue to subscribe. Further variations on a subscription business model may specify alternative expiration periods and rights grants/licenses that do not renew automatically with each subscription period. For example, a movie distributor may choose to grant their subscribers with access to up to 30 feature films each month, and grant them rights to those movies for up to 90 days, while denying renewal for those rights grants/licenses for a period of 6 months following the initial rights grant/license period.

An alternative to subscription-based business models is a pay-per-view (PPV) business model, in which users may select and purchase rights to consume (e.g., not just view) individual content items where the rights do not automatically renew. For example, a consumption rights grant/license granted under a PPV model might grant a user 5 days of usage, 7 playbacks, or 3 CD burns, and might do so for any specified number of content items. One variation to the pure, single-item PPV model is the bundle model, in which consumers purchase a package representing some number of credits or tokens for content items belonging to a specific class of content. The users may then choose from any of the available items in the content class, consuming credits as they acquire consumption rights grants/licenses, until the purchase is fulfilled (e.g., all credits have been consumed).

Some content partners may choose to implement a hybrid of subscription and PPV business models. For example, one or more online music services may offer unlimited, subscription-based playback of streamed or downloaded tracks, but may require incremental payment for CD burning. CD burning, for example, may be based on a separate, co-existent subscription regulated by metering, or may simply require the purchase of burn credits.

In accordance with one embodiment of the invention, the content provider may be equipped with configurable business rules logic supporting a variety of content distribution/licensing business rules based on combinations of various types of entitlement, including but not limited to subscription, pay-per-view, and metering based entitlements. In one embodiment of the invention, content rights broker 102 may utilize an ordered arrangement of rights templates to implement an associated distribution/licensing business model. Each rights template may be associated with one or more rules, and one or more consumption rights grants that may be conferred upon a client/consumer for a given content item upon successful application of that set of corresponding rules. A rule may be considered to be successfully applied if a corresponding logic expression evaluates to true. In one embodiment, the logic expressions are Boolean in nature. In one embodiment, each time a client requests authorization for consumption of a particular content item, attributes of the client, the consumer, or the request itself may be processed against one or more rights templates to determine which sets of rights to grant the consumer with respect to the requested content item. In one embodiment, rights templates may be arranged into one or more ordered rights template chains and one or more rights template chains may be arranged into an ordered consumption rights matrix. In one embodiment of the invention, rights template chains and consumption rights matrices may be generated so as to represent content partner-specific content item distribution/licensing business models.

### Example Content Distribution/Licensing Business Model

Assume, for the purpose of example, a movie partner (MP) wishes to offer a subscription-based service for the delivery of downloadable feature films. The service is to be tiered to give consumers a limited number of subscription packages from which to choose. Additionally, MP will run promotions from time-to-time that will grant limited, free access to their content, constrained on both time (e.g. such as free weekends) and quantity (e.g. up to 5 movies) that will be made available to both subscribers of a movie partner package and non-subscribers alike. Under the MP plan, “Superpass” subscribers will be entitled to receive up to 3 plays per movie of any 8 movies per month selected from a total catalog of over 500 films; “MoviePass Gold” subscribers will be entitled to a maximum of 3 plays per movie of any 20 movies per month; and “MoviePass Platinum” subscribers will have unlimited access to movies, providing an unlimited number of playbacks per movie within any 30 day period. Furthermore, non-subscribers may purchase movies in 5-packs, with each movie pack providing up to 3 plays per movie.

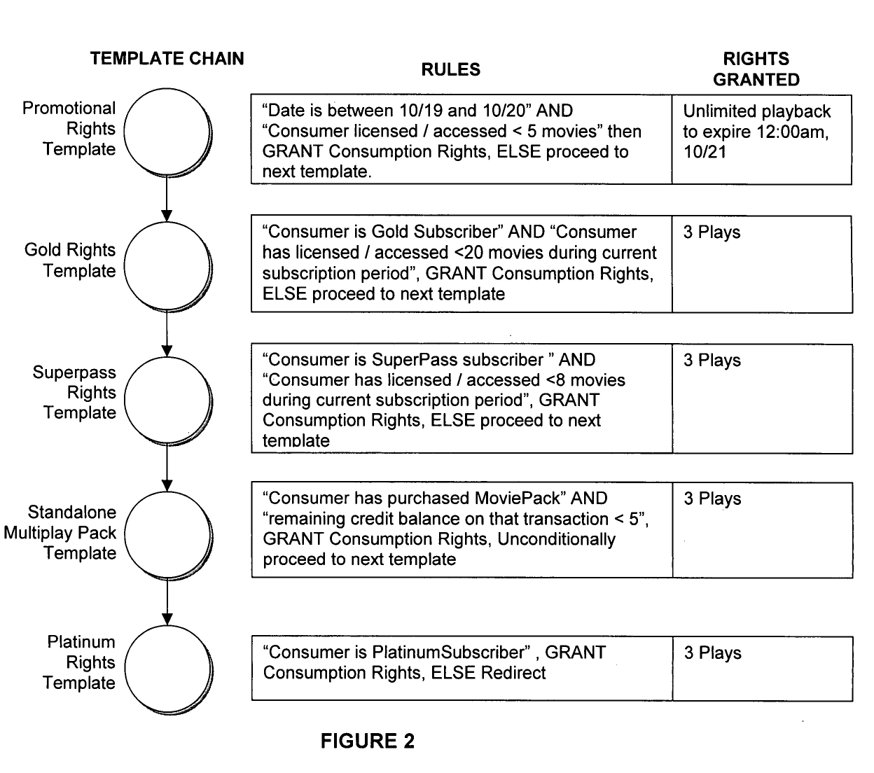

FIG. 2 illustrates one embodiment of a rights template chain and corresponding rules and consumption rights grants, representing the example MoviePass content distribution/licensing business model described above. In one embodiment, the set of rights to be granted to a client may be determined by traversing each of the rights templates in sequential order starting with a root template (i.e. head of a template chain), and evaluating the rule expressions corresponding to each rights template.

For example, if in response to a consumer's request to consume a particular content item, it is determined that the current date is either October 19^{th} or 20^{th}, and the consumer has previously licensed less than 5 movies (or otherwise been granted consumption rights for less than 5 movies), the consumer may be granted unlimited playback of the requested content item until 12:00 am on October 21^{st} based on the promotional rights template of FIG. 2. However, if any of these preconditions is not met, then the next rights template in the rights template chain is applied. More specifically, a determination may be made as to whether the consumer is a “Gold” subscriber and whether the consumer has licensed or has otherwise been granted consumption rights for less than 20 movies during the current subscription period. If so, the consumer may be granted 3 plays of the requested content item. If not, a further determination is made as to whether the consumer is a “Superpass” subscriber and whether the consumer has licensed or has otherwise been granted consumption rights for less than 8 movies during the current subscription period. If the consumer is a “Superpass” subscriber and has licensed or has been granted consumption rights for less than 8 movies during the current subscription period, the consumer may be granted 3 plays of the requested content item. If the consumer is not a “Superpass” subscriber or the consumer has licensed or has otherwise been granted consumption rights for 8 or more movies, a determination may be made as to whether the consumer has purchased a “moviepack” and whether the consumer's remaining credit balance is less than 5. If so, the consumer may be granted 3 plays of the requested content item. However, if the consumer has not purchased a “moviepack” or the consumer's remaining credit balance is not less than 5, and the consumer is a “platinum” subscriber, then the consumer may be granted 3 plays of the requested content item.

In one embodiment, one or more rights templates in a given rights template chain may be associated with a failure message that is utilized in the event a corresponding rule expression evaluates to false. In one embodiment, the failure message may be provided in the form of a Uniform Resource Locator (URL) that is used to redirect the client to a web page offering the consumer an opportunity to purchase additional consumption rights or services from the partner.

### Consumption Rights Matrix Navigation

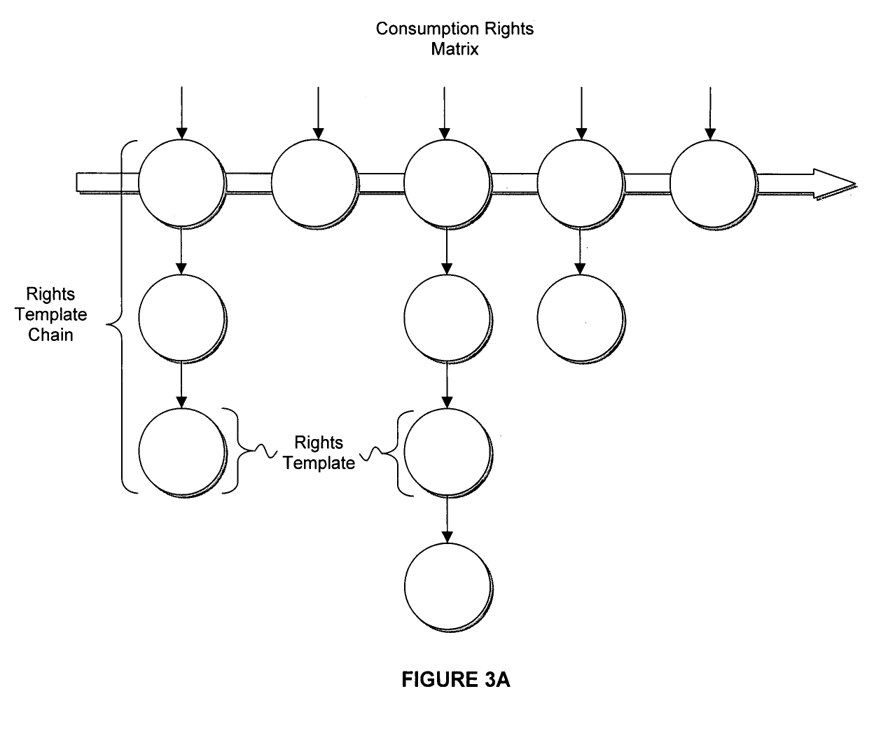

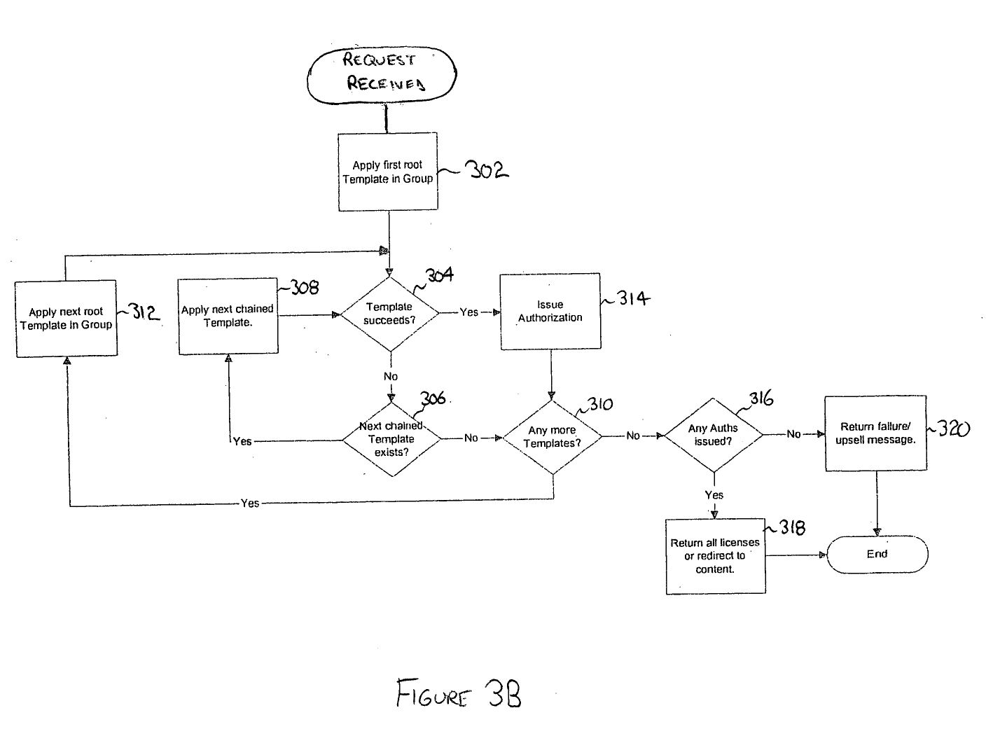

In one embodiment, a matrix of consumption rights may be formed from the combination of two or more rights template chains. FIG. 3A illustrates one embodiment of a consumption rights matrix formed from an ordered grouping of rights templates arranged into one or more rights template chains with each rights template chain comprising two or more rights templates. In other embodiments, a single rights template chain may comprise a single rights template member. In one embodiment of the invention, rights templates of a given consumption rights matrix may be traversed in a predetermined order to identify a set of rights to be granted with respect to a corresponding content item. As each rights template within a consumption rights matrix is selected, a set of rules associated with the selected rights template may be applied to determine whether a corresponding set of consumption rights should be granted. In one embodiment, multiple sets of consumption rights or licenses may be granted through the traversal of a consumption rights matrix.

Consumption rights matrices may be traversed in a variety of ways, depending e.g. upon the particular business model represented. For example, in one embodiment each rights template chain may be composed of two or more mutually exclusive sets of rights. Accordingly, once a single grant set has been determined within a given rights template chain, remaining rights templates within that rights template chain may be skipped and the next sequential rights template chain examined.

FIG. 3B is an operational flow diagram illustrating one method for traversing a consumption rights matrix, in accordance with one embodiment of the invention. As shown in FIG. 3B, in response to a content item consumption request being received, the first rights template in the first rights template chain found within the consumption rights matrix is selected and the rule expression corresponding to the selected rights template is evaluated (block 302). If the rule expression evaluates to true, the template is considered to have succeeded, whereas if the rule expression evaluates to false, the template is considered to have failed. If the first rights template of a rights template chain fails (block 304), a determination is made as to whether another rights template exists within the same rights template chain (block 306). If another rights template belonging to the same rights template chain exists, the next rights template in the rights template chain is selected and the rule expression corresponding to that rights template is then evaluated (block 308). If, however at block 306, it is determined that another rights template does not exist within the same rights template chain, a further determination is made as to whether any additional rights templates chains exist (block 310).

If additional rights template chains exist, the next root rights template in the next rights template chain is selected (block 312) and the rule expression corresponding to the new rights template is evaluated to determine whether the template succeeds (block 304). If the selected rights template succeeds, an authorization such as a consumption right or license is granted (block 314), and if additional rights template chains exist, the next rights template chain in the matrix is selected, ignoring any remaining rights templates in the current chain. The process repeats until no additional rights templates remain. At that time, a determination is made as to whether any authorizations have been issued (block 316). If so, the issued authorizations (whether in the form of one or more consumption rights grants or one or more licenses) are returned to the client (block 318). Otherwise, a message indicating the absence of an authorization or presenting an opportunity to upgrade existing consumption rights is returned to the client (block 320).

### Consumption Rights Matrix Generation

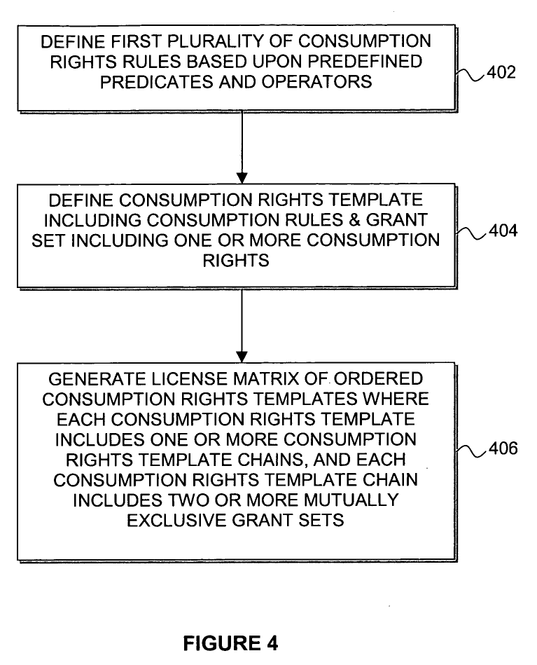

FIG. 4 illustrates an operational flow of a consumption rights matrix generation process, in accordance with one embodiment of the invention. In the illustrated embodiment, one or more consumption rules may be defined from a group of predetermined predicates and operators (block 402). In one embodiment, the operators may be Boolean based operators and the predicates may take on a variety of forms, such as entitlements, Internet Protocol (IP) address ranges, geography, dates, promotional licensing, user and/or machine licensing history, and so forth.

Once one or more consumption rules have been defined, one or more rights templates may be then be defined based at least in part upon the consumption rules. In one embodiment, each rights template may include one or more consumption rules and one or more consumption rights grants (block 404). Consumption rights grants (or grant sets) represent rights that may be conferred upon a client/consumer for a given content item upon successful application of one or more corresponding rules. In one embodiment, consumption rights grants may be specific to, and therefore be determined based upon a particular consumption rights and/or licensing server utilized. For example, the license server in the Helix DRM, from RealNetworks, is capable of granting content item rights in the form of licenses indicating the number of times a particular content item can be played (play count), the number of times a particular content item can be downloaded to a portable device (download count), the duration of the license, and so forth.

Once a group of rights templates has been defined, the rights templates may be organized into a consumption rights matrix containing one or more ordered chains of rights templates (block 406). In one embodiment, each rights template chain includes two or more mutually exclusive grant sets. In one embodiment, each content item is associated with a single consumption rights matrix, however each matrix may be associated with one or more content items.

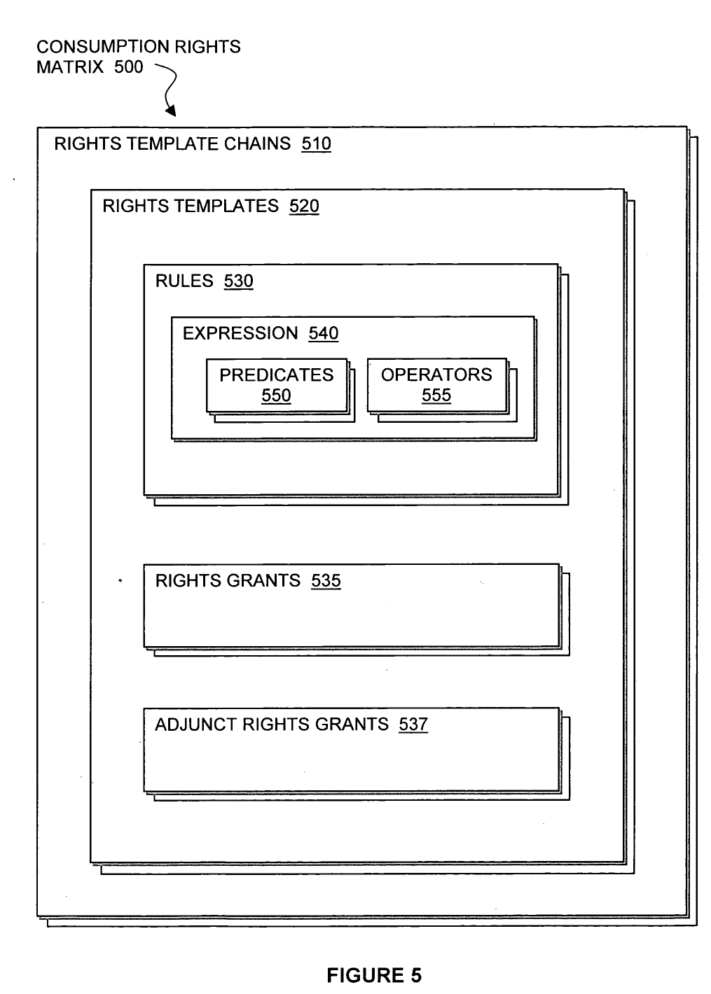

FIG. 5 illustrates one embodiment of a consumption rights matrix including various member elements. As shown in the illustrated embodiment, consumption rights matrix 500 may include one or more rights template chains 510, with each of the rights template chains 510 including one or more rights templates 520. Each rights template 520 may further include one or more consumption rules 530, one or more consumption rights in the form of a rights grant set 535, and one or more adjunct rights grants 537 (described below). In turn, each of the consumption rules 530 may be composed of a single rule expression 540, which may be formed from one or more predicates 550 and one or more operators 555.

### Example User Interface

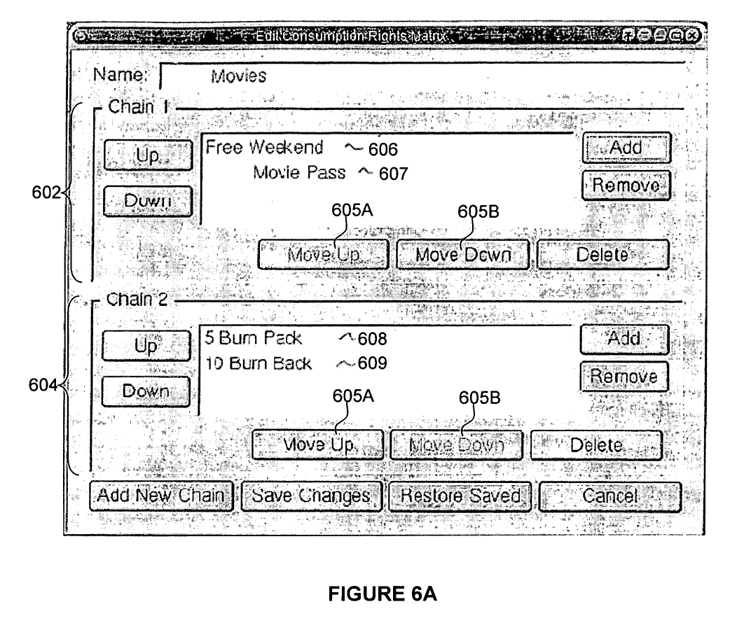

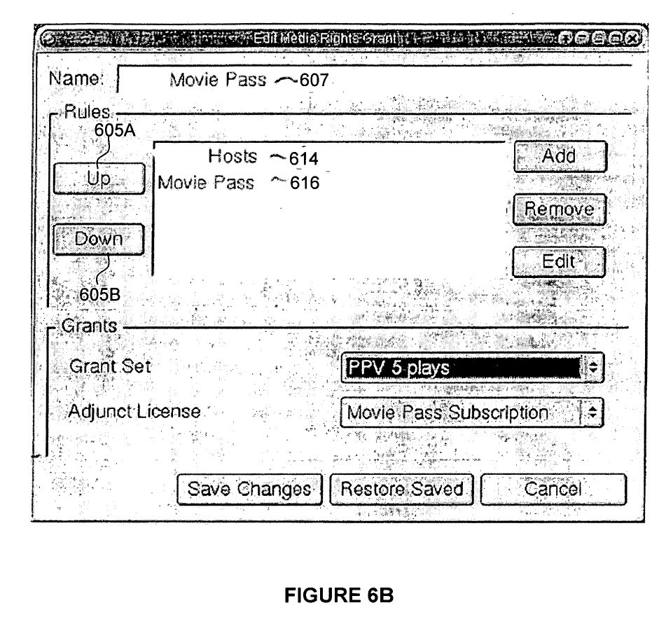

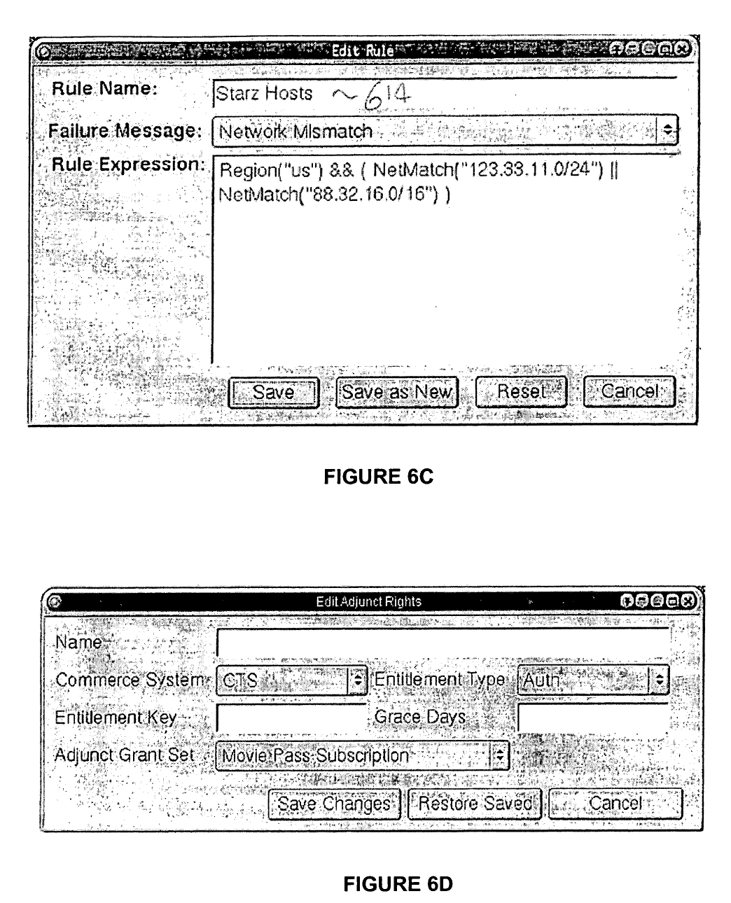

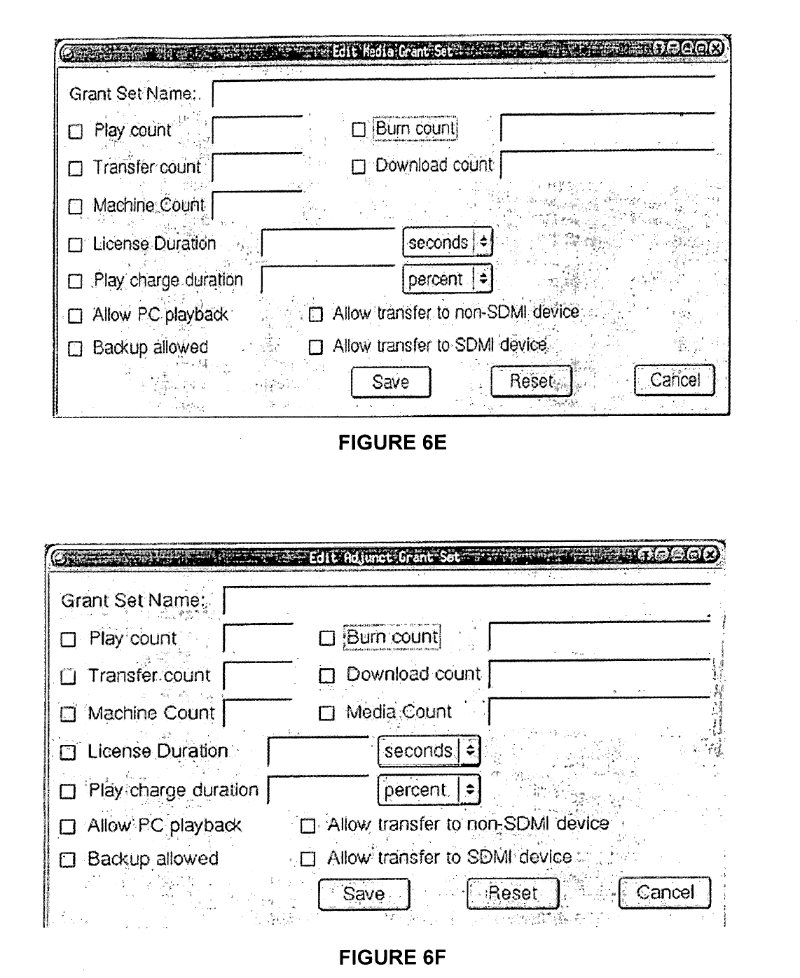

FIGS. 6A-6F illustrate various user interface dialogs for consumption rights matrix generation in accordance with one embodiment of the invention. In one embodiment of the invention, data provided via the illustrated consumption rights matrix generation dialogs is captured in an extensible markup language (XML) based data structure for processing by business rules engine 106. In one embodiment, the consumption rights matrix data structures are stored in data repository 108.

FIG. 6A illustrates an example matrix editing dialog through which a consumption rights matrix may be defined in accordance with one embodiment of the invention. As shown, a consumption rights matrix entitled “Movies” is defined to include a first rights template chain 602, and a second rights template chain 604. Rights template chain 602 is further defined to include rights templates 606 and 607, whereas rights template chain 604 is further defined to include rights templates 608 and 609. In one embodiment of the invention, the order with which rights templates appear within a given rights template chain may affect the outcome of the application of corresponding consumption rules. Accordingly, the consumption rights matrix editing dialog of FIG. 6A includes facilities to change the order of individual rights templates within a given chain (605a, 605b).

FIG. 6B illustrates an example dialog through which a content item rights grant may be defined in accordance with one embodiment of the invention. As shown, rights template 607 includes rule set 610 (defined to include rules 614, 616), and grant set 612 representing rights to be granted upon successful application of rule set 610. In one embodiment of the invention, the order with which rules are applied may affect the outcome of rule application. Accordingly, as with rights template chains 602 and 604, the editing dialog of FIG. 6B includes facilities (605a, 605b) to change the order of individual consumption rules within rule set 610.

The illustrated editing dialog of FIG. 6B further includes adjunct rights grant facilities for a user to indicate an adjunct rights grant to be applied to an associated rights template such as rights template 607. In one embodiment, adjunct rights grants describe master rights for a particular body of content and comprise at least two general classes. One class of adjunct rights grants may represent standard DRM rights, as e.g. supported by a License Server, but which may be delivered to the client in the form of a subscription or parent license. In one embodiment, parent licenses provide rights for one or more content items such that the content items obey the same usage restrictions. Accordingly, content items associated with a particular parent license may be renewed with a single update to the parent license rather than updating each content license individually. The second class of adjunct rights grants are referred to as metarights, or server-based rights that determine the delivery of DRM rights. For example, a restriction on the number of clients through which a particular user may receive consumption rights grants for a specific content item would be a server-enforced right that is managed by the Content Rights Broker, but may nonetheless remain unknown to the DRM solution or the License/Consumption Rights Server. Another example of a metaright is content metering, which may specify the number of unique content items for which a user may receive consumption rights grants during any given subscription period.

FIG. 6C illustrates an example rule editing dialog through which a user may define and/or edit a new consumption rule in accordance with one embodiment of the invention. As shown, consumption rule 614 is defined to include a rule expression 622, including one or more predicates (e.g. Region(“US”)) and one or more Boolean operators (e.g. “&&”, “∥”) to be evaluated. Consumption rule 614 further includes a failure message 625 that is associated with consumption rule 614, such that upon unsuccessful application of rule expression 622, failure message 625 is utilized. In one embodiment, failure message 625 is provided in the form of a URL that the client is redirected to in the event the application of a corresponding rule expression is not successful.

FIG. 6D illustrates an example adjunct rights grant editing dialog through which a user may edit an adjunct consumption rule in accordance with one embodiment of the invention. The Adjunct rights grant editing dialog may be used to specify global rights, including server-based rights, or metarights, that apply to a particular entitlement for a particular body of content.

FIG. 6E illustrates an example grant set edit dialog through which a user may define a set of consumption rights grants to be conferred upon a consumer upon successful application of one or more corresponding consumption rules.

FIG. 6F illustrates an example adjunct grant set edit dialog through which a user may define a set of adjunct rights to be conferred upon a consumer. In addition to standard DRM rights, adjunct rights may include machine counts and media counts. In one embodiment, when an adjunct license is combined with a content license in a parent/child relationship, the license having the most restrictive rights is applied to the content item.

### Content Item Consumption Requests

In one embodiment of the invention, in response to a consumer's attempt to consume a content item, user agent 112 may determine whether a preexisting license or consumption rights grant for the subject content item is present on client 110. In the event a preexisting license or consumption rights grant for the content item is not present on client 110, client 110 may proceed to generate a content item consumption request, and transmit the request to content rights broker 102. In one embodiment, the client request may take the following form:

```
http://start.real.com/sede/license.jsp?
    ClientPubKey={ }
    &Challenge={ }
    &ExtraInfo={ }
    &ContentGUID={ }
```

In one embodiment, “ClientPubKey”, “Challenge”, and “ExtraInfo” may represent values generated by e.g. user agent 112 that are to be transmitted in association with the request, whereas the “ContentGUID” value may represent an identifier (e.g. such as a globally unique identifier (GUID)) that has been previously associated with the content item to uniquely identify the requested content item to content rights broker 102, for example.

In one embodiment, in response to receiving the client request, content rights broker 102 may proceed to generate a second consumption request to be transmitted to consumption rights server 120. In one embodiment, the consumption request from content rights broker 102 may take the form of a license request as follows:

```
http://<server IP>:8080/drm/license.txt?
    ClientPubKey={ }&
    Challenge = { }&
    ExtraInfo = { }&
    ContentGUID = { }&
    ContentKey = { }&
    LicenseDuration = { }&
    DownloadInterval = { }&
    Rights = { },
```

where “ClientPubKey”, “Challenge”, “ExtraInfo”, and “ContentGUID” correspond to the values described above, and “LicenseDuration” and “DownloadInterval” may represent the amount of time an associated license will remain valid after reception and the amount of time allowed between a client requesting the license and the client adding the license to a local license database, respectively. In one embodiment, “ContentKey” may represent an encryption key (or portion thereof) needed to decrypt the requested content item. In one embodiment, the “ContentKey” may be generated by a content partner during publication of the content item. In one embodiment, the “ContentKey” may be associated with the requested content item based upon the unique identifier (i.e. the “ContentGUID”) and may be stored in data repository 108. Lastly, “Rights” may represent one or more rights identified by content broker 102 to be granted in response to successful application of one or more corresponding rules. In one embodiment, the identified rights may be selected from a group of rights that are determined based upon the particular licensing authority/license server involved.

In one embodiment, a license returned from consumption rights server 120 may be decipherable only to user agent 112, and may take the form of a hashed string prefixed with a license identifier as follows:
lice://4erMw#go095TjOi(*&#Jgp . . . )

### Content Rights Broker Operational Flow

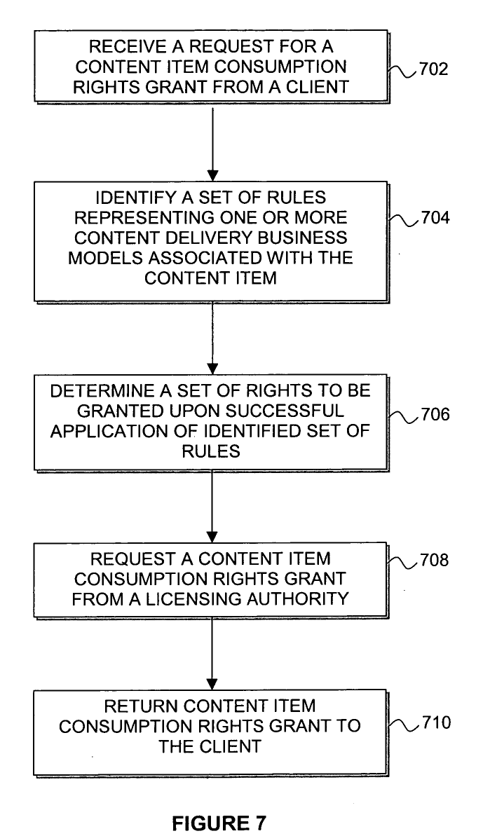

FIG. 7 illustrates an example operational flow for content rights broker 102, in accordance with one embodiment of the invention. The illustrated process begins with the content rights broker receiving a request for a content item consumption rights grant from a client (block 702). Upon receipt of the request, content rights broker 102, or more specifically, rules engine 106 may identify an appropriate set of rules representing one or more content distribution/licensing business models associated with the requested content item (block 704). Rules engine 106 may further determine a set of content item consumption rights to be granted to client 110, based upon successful application (e.g., evaluation) of the identified set of rules (block 706). In one embodiment, rules engine 106 may identify the set of rules and rights based upon one or more rights templates. Once the set of distribution/licensing business rules to be applied are determined, content rights broker 102 may generate a consumption request which is transmitted to consumption rights server 120 in order to obtain an appropriate content item consumption rights grant based upon the identified set of rights (block 708). Once the content item consumption rights grant is received from consumption rights server 120, content rights broker 102 may then provide client 110 with the content item consumption rights grant on behalf of the consumer (block 710). In one embodiment, content rights broker 102 may generate a content license request which is transmitted to consumption rights server 120 in order to obtain an appropriate content item license and an optional subscription license based upon the identified set of rights. Furthermore, once the content item license and optional subscription license are received from consumption rights server 120, content rights broker 102 may then provide client 110 with the content item license and optional subscription license on behalf of the consumer.

### Example Architecture

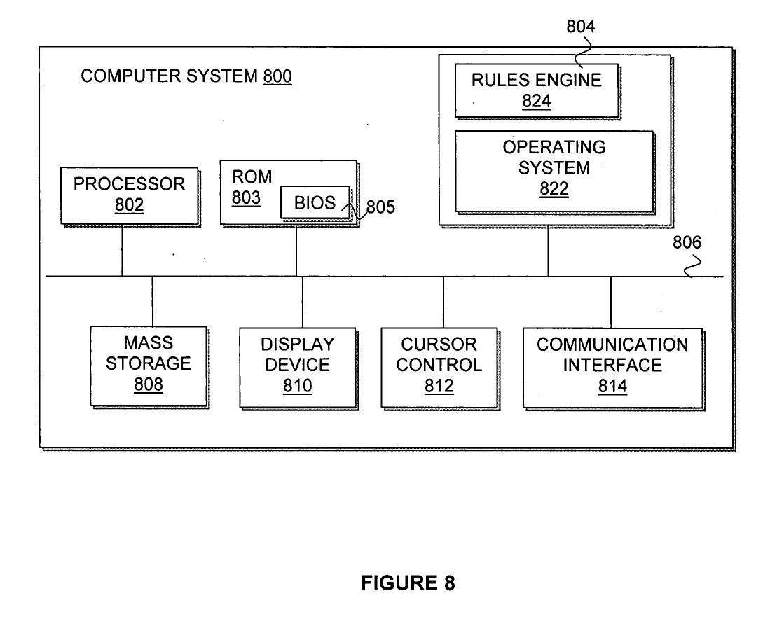

FIG. 8 illustrates an example system suitable for practicing the present invention. As shown, example computer system 800 includes processor 802, ROM 803 including basic input/output system (BIOS) 805, and system memory 804 coupled to each other via “bus” 806. Also coupled to “bus” 806 are non-volatile mass storage 808, display device 810, cursor control device 812 and communication interface 814. During operation, memory 804 may include working copies of operating system 822, and implementing logic of configurable business rules engine (rules engine) 824 of the present invention to facilitate content item licensing.

Except for the teachings of the present invention as incorporated herein, each of these elements may represent a wide range of these devices known in the art, and otherwise performs its conventional functions. For example, processor 802 may be a processor of the Pentium® family available from Intel Corporation of Santa Clara, Calif., which performs its conventional function of executing programming instructions of operating system 822 and rules engine 824, including those implementing the teachings of the present invention. ROM 803 may be EEPROM, Flash and the like, and memory 804 may be SDRAM, DRAM and the like, from semiconductor manufacturers such as Micron Technology of Boise, Id. Bus 806 may be a single bus or a multiple bus implementation. In other words, bus 806 may include multiple properly bridged buses of identical or different kinds, such as Local Bus, VESA, ISA, EISA, PCI and the like.

Mass storage 808 may represent disk drives, CDROMs, DVD-ROMs, DVD-RAMs and the like. Typically, mass storage 808 includes the permanent copy of operating system 822 and rules engine 824. The permanent copy may be downloaded from a distribution server through a data network (such as the Internet), or installed in the factory, or in the field. For field installation, the permanent copy may be distributed using one or more articles of manufacture such as diskettes, CDROM, DVD and the like, having a recordable medium including but not limited to magnetic, optical, and other mediums of the like.

Display device 810 may represent any of a variety of display types including but not limited to a CRT and active/passive matrix LCD display, while cursor control 812 may represent a mouse, a touch pad, a track ball, a keyboard, and the like to facilitate user input. Communication interface 814 may represent a modem interface, an ISDN adapter, a DSL interface, an Ethernet or Token ring network interface and the like.

### Epilog

While the present invention has been described in terms of the above-illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A method comprising:
receiving a request for a consumption rights grant for a content item from a client on behalf of a consumer;
identifying a set of rules representing one or more content delivery models associated with the content item;
determining a set of rights to be granted to the client with respect to the content item based upon successful application of the identified set of rules;
requesting the consumption rights grant from a rights provisioning authority based at least in part upon the determined set of rights;
obtaining the consumption rights grant from the rights provisioning authority; and
returning the consumption rights grant to the client on behalf of the consumer.

2. The method of claim 1, further comprising:
identifying subscription information associated with the consumer; and
determining whether the consumer is entitled to receive a consumption rights grant for the content item based at least in part upon the subscription information.

3. The method of claim 1, wherein each of the set of rules comprises one or more named Boolean expressions with each named Boolean expression comprising one or more operators and one or more predicates.

4. The method of claim 3, wherein each of the set of rules is associated with a failure message to be provided to the client if application of a corresponding Boolean expression is not successful.

5. The method of claim 1, wherein the one or more content delivery models comprise at least one of a subscription model wherein consumers pay a reoccurring periodic charge for rights to consume one or more content items belonging to a content class, a pay-per-view model wherein consumers purchase rights to consume individual content items, and a hybrid model including consumption rights derived from both the subscription and the pay-per-view models.

6. The method of claim 5, wherein consumer consumption rights are determined by the rights provisioning authority.

7. The method of claim 6, wherein consumer consumption rights comprise one or more of a viewing right, a download right, and a CD-burn right.

8. The method of claim 1, wherein the request is received in response to a consumer attempting to cause the content item to be rendered via a content player.

9. A method comprising:
receiving from a client, a request to consume a content item;
traversing a matrix of rights templates associated with the content item to identify a set of rights to be granted to the client in response to the received request, the rights templates arranged in an ordered grouping of one or more rights template chains with each rights template chain comprising two or more sets of mutually exclusive rights;
requesting a consumption rights grant for the content item from a rights provisioning authority based at least in part upon the identified set of rights; and
providing the consumption rights grant to the client to facilitate consumption of the content item by the client.

10. The method of claim 9, wherein each of the rights templates comprises a set of one or more rules and a set of one or more rights associated with the content item to be granted to the client based upon successful application of the set of one or more rules.

11. The method of claim 10, wherein each of the set of one or more rules comprises one or more named Boolean expressions and a message to be provided to the client if application of the Boolean expression is not successful.

12. The method of claim 11, each named Boolean expression comprises one or more operators and one or more predicates.

13. The method of claim 9, wherein the matrix of rights templates represents one or more content delivery models.

14. The method of claim 13, wherein the one or more content delivery models comprise at least one of a subscription model wherein consumers pay a reoccurring periodic charge for rights to consume one or more content items belonging to a content class, a pay-per-view model wherein consumers purchase rights to consume individual content items, and a hybrid model including consumption rights derived from both the subscription and the pay-per-view models.

15. A method comprising:
defining a plurality of content item consumption rules, each of the consumption rules including at least a first rule expression based upon a selected one or more of a plurality of predefined predicates and operators;
defining a first rights template to include a selected one of the plurality of consumption rules and a grant set of one or more consumption rights grants to be conferred based upon successful application of a corresponding rule expression; and
generating a consumption rights matrix to facilitate granting of one or more content item consumption rights grants in response to a request received from a client, the consumption rights matrix comprising an ordered arrangement of rights templates associated with the content item, wherein the ordered arrangement of rights templates comprises one or more rights template chains with each rights template chain comprising two or more mutually exclusive grant sets.

16. The method of claim 15, wherein at least one of the plurality of consumption rules further comprises a failure message to be delivered to the client request fails a corresponding rule such that the request cannot be fulfilled.

17. The method of claim 15, wherein the consumption rights matrix represents one or more models for content item delivery.

18. The method of claim 17, wherein the one or more models for content item delivery comprise at least one of a subscription model wherein consumers pay a reoccurring periodic charge for rights to consume one or more content items belonging to a content class, a pay-per-view model wherein consumers purchase rights to consume individual content items, and a hybrid model including consumption rights derived from both the subscription and the pay-per-view models.

19. A machine readable medium having stored thereon machine executable instructions, which when executed operate to implement a method comprising:
receiving a request for a consumption rights grant for a content item from a client on behalf of a consumer;
identifying a set of rules representing one or more content delivery models associated with the content item;
determining a set of rights to be granted to the client with respect to the content item based upon successful application of the identified set of rules;
requesting the consumption rights grant from a rights provisioning authority based at least in part upon the determined set of rights;
obtaining the consumption rights grant from the rights provisioning authority; and
returning the consumption rights grant to the client on behalf of the consumer.

20. (canceled)

21. (canceled)

22. (canceled)

23. (canceled)

24. (canceled)

25. (canceled)

26. (canceled)

27. A machine readable medium having stored thereon machine executable instructions, which when executed operate to implement a method comprising:
receiving from a client, a request to consume a content item;
traversing a matrix of rights templates associated with the content item to identify a set of rights to be granted to the client in response to the received request, the rights templates arranged in an ordered grouping of one or more rights template chains with each rights template chain comprising two or more sets of mutually exclusive rights;
requesting a consumption rights grant for the content item from a rights provisioning authority based at least in part upon the identified set of rights; and
providing the consumption rights grant to the client to facilitate consumption of the content item by the client.

28. (canceled)

29. (canceled)

30. (canceled)

31. (canceled)

32. (canceled)
